(19) United States
(12) Patent Application Publication
(10) Pub. No.: US 2010/0060417 A1
(43) Pub. Date: Mar. 11, 2010

(54) BIOMETRICS AUTHENTICATION DEVICE AND BIOMETRICS AUTHENTICATION METHOD

(75) Inventor: Koichiro NIINUMA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/534,167

(22) Filed: Aug. 3, 2009

(30) Foreign Application Priority Data
Sep. 5, 2008 (JP) 2008-228379

(51) Int. Cl. G05B 19/00

(52) U.S. Cl. 340/5.82

(57) ABSTRACT

A biometrics authentication device includes a registered data retaining unit to retain registered data, a verification data retaining unit to retain a plurality of pieces of verification data used for verification with the registered data, and a registered data generation unit to extract feature information of high reproducibility from the verification data in the verification data retaining unit and the registered data in the registered data retaining unit and to generate new registered data from extracted feature information, wherein by the new registered data generated by the registered data generation unit, the registered data in the registered data retaining unit is updated.

### CROSS-REFERENCE TO RELATED APPLICATION

This application is based upon and claims the benefit of priority of the prior Japanese Patent Application No. 2008-228379, filed on Sep. 5, 2008, the entire contents of which are incorporated herein by reference.

### FIELD

The embodiments discussed herein are related to a device and a method supplied for biometrics authentication that uses biometrics information such as fingerprint information, and a program thereof.

### BACKGROUND

These days, biometrics authentication such as fingerprint authentication attracts attention as the art realizing personal identification of high reliability, and is used in various fields.

Biometrics authentication must be adaptable to change over the years. For example, in fingerprint authentication, fingerprints are used as unique information for identifying an individual. As fingerprints are a part of a skin, a state thereof may change by time passing and the like. That is, there may be a case that even if fingerprint authentication is performed for one individual, an authentication rate drops more than past authentication for the same individual by time passing since registration and the like.

As an attempt to avoid a drop in an authentication rate as described above, for example, Japanese Patent No. 3479871 discloses a method that when data for registration is updated, the data for registration is replaced with data for collation. In this method, since data for registration is replaced with data for collation at that time, there is a risk that if a collation error occurs at timing of updating data for registration, the data for registration is replaced with others' data. In biometrics authentication, possibility of a collation error cannot be completely excluded. Thus, this risk cannot be ignored. In addition, since data for registration is generated from only biometrics information obtained from one operation, it cannot be avoided that feature information of low reliability is registered.

As another attempt, for example, Japanese Laid-open Patent Publication No. 2003-36441 discloses a method that when registered data is updated, the registered data is replaced with any of a plurality of pieces of past collation data being held. In this method, since registered data is replaced with any of a pieces of past collation data, the risk of replacing the registered data with data of others' fingers still remains. Even in this method, since registered data is generated from biometrics information obtained from one operation, it cannot be avoided that feature information of low reliability is registered.

As further another attempt, for example, Japanese Laid-open Patent Publication No. H04-320583 describes a method that when registered data is updated, defective feature points of the registered data (a binary image, ridge direction data, etc.) are replaced with feature points of collating data at that time. In this method, if a collation error occurs at timing of updating registered data, there is a risk that a part of feature points (a binary image and ridge direction data) are replaced with others'. This method is adaptable only to a specific method such as a moving window method.

As other attempts, for example, Japanese Laid-open Patent Publication No. 2002-163654 discloses a controller to renew dictionary data correspondingly to a change in the face feature amount of a user. Japanese Laid-open Patent Publication No. 2001-344604 discloses a living body feature data composing method wherein feature points are extracted from plural fingerprint pictures, and out of the extracted feature points, composed fingerprint data of only feature points of high reproducibility is prepared. Japanese Laid-open Patent Publication No. 2006-12080 discloses biological information authentication device wherein feature points are extracted from a plurality of fingerprint pictures, and out of the extracted feature points, composed fingerprint data of only feature points of high reproducibility is set as registered data. Japanese Laid-open Patent Publication No. 2000-57343 discloses a fingerprint collating method wherein update of registered data is not performed every time, but is performed only when performing collation is getting more and more difficult.

In such authentication using biometrics information, if registered data is not updated at all in operation of the authentication, there is a risk that a verification rate drops by change of a living body over the years because the registered data has not been updated since registration. If the feature amount of low reliability (for example, a feature point which is erroneously determined to be an end point by a hurt) was registered in registration, it possibly causes a verification error such as acceptance of others or refusal of an original.

If feature data is simply replaced with verification data at operation of feature data by certain period, it possibly causes a verification error since there is possibility that the registered data is erroneously replaced with another piece of biometrics information at timing when verification with others is performed. Even if the verification data is original's, it cannot be avoided that the feature amount of low reliability is registered if registered data is generated from information from only once verification (registration).

Like the above, in authentication using biometrics information, it is necessary that registered data is updated to the latest data for being adaptable to change of a living body over the years and avoiding occurrence of a verification error. If updating of registered data is carelessly performed, there appears a risk of replacement with others' data in the updating. Avoiding such inconvenience is essential for improving authentication accuracy.

Concerning such requests and problems, there is no disclosure or suggestion thereof in Japanese Patent No. 3479871 and Japanese Laid-open Patent Publications Nos. 2003-36441, H04-320583, 2002-163654, 2001-344604, 2006-12080 and 2000-57343, and there is no disclosure or suggestion about structure solving them and so on.

### SUMMARY

A first aspect of embodiments of the present invention is a biometrics authentication device including a registered data retaining unit to retain registered data, a verification data retaining unit to retain a plurality of pieces of verification data used for verification with the registered data, and a registered data generation unit to extract feature information of high reproducibility from the verification data in the verification data retaining unit and the registered data in the registered data retaining unit, and to generate new registered data from extracted feature information, wherein by the new registered data generated by the registered data generation unit, the registered data in the registered data retaining unit is updated.

According to such structure, registered data used for authentication is retained in the registered data retaining unit, and a plurality of pieces of verification data (verification data used for past authentication and the like) are retained in the verification data retaining unit. The registered data generation unit extracts feature information of high reproducibility from the verification data in the verification data retaining unit and the registered data in the registered data retaining unit, and generates new registered data by the extracted feature information. This new registered data allows the current registered data in the registered data retaining unit updated. That is, when the registered data is updated in biometrics authentication, reliability of the feature amount is evaluated from each of past plural times of verification data, and the feature amount to be updated is determined based on the reliability. Thus, update to registered data of high reliability can be performed, inconvenience that registered data embraces others' feature information can be avoided and an authentication error such as acceptance of others and refusal of an original can be prevented.

A second aspect of embodiments of the present invention is a computer readable and writable recording medium storing a biometrics authentication program, the program being executed by a computer, the program includes retaining registered data, retaining a plurality of pieces of verification data used for verification with the registered data, extracting feature information of high reproducibility from the verification data and the registered data and generating new registered data from extracted feature information, and updating the registered data by newly generated registered data.

A third aspect of embodiments of the present invention is a biometrics authentication method performing authentication by biometrics information, the method including retaining registered data, retaining a plurality of pieces of verification data used for verification with the registered data, extracting feature information of high reproducibility from the verification data and the registered data and generating new registered data from extracted feature information, and updating the registered data by newly generated registered data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

Other objects, features and advantages of the present invention are more clearly understood by referring to the attached drawings and each of embodiments.

### BRIEF DESCRIPTION OF DRAWINGS

FIG. 1 depicts a fingerprint authentication device according to a first embodiment;

FIG. 2 is a flowchart depicting processing procedure of verification;

FIG. 3 is a flowchart depicting processing procedure of registered data update;

FIGS. 4A and 4B depict a process of registered data update;

FIGS. 5A and 5B depict a process of registered data update;

FIGS. 6A and 6B depict another process of registered data update;

FIGS. 7A and 7B depict another process of registered data update;

FIGS. 8A-8C depict a verification process where registered data is weighted;

FIGS. 9A-9C depict a verification process where registered data is weighted;

FIG. 10 is a flowchart depicting processing procedure of a registered data updating process according to a third embodiment;

FIG. 11 is a flowchart depicting processing procedure of a registered data updating process according to a fourth embodiment;

FIG. 12 depicts a hardware configuration of a fingerprint authentication device according to a fifth embodiment;

FIG. 13 depicts a PC where a fingerprint authentication device is mounted;

FIG. 14 depicts a portable device where a fingerprint authentication device is mounted; and

FIG. 15 depicts a PDA where a fingerprint authentication device is mounted.

### DESCRIPTION OF EMBODIMENTS

The embodiments of the present invention has a verification data retaining means (part) storing a plurality of pieces of verification data which were used in past authentication, extracts the feature amount (information) of high reproducibility in updating registered data from the past verification data retained in the verification data retaining means (part) and current registered data, generates new registered data based on reliability by evaluation of the reliability of the feature amount, and updates the registered data to the new registered data. As a result, reliability according to updating of registered data is improved, and an authentication error by change of biometrics information over the years can be prevented.

### First Embodiment

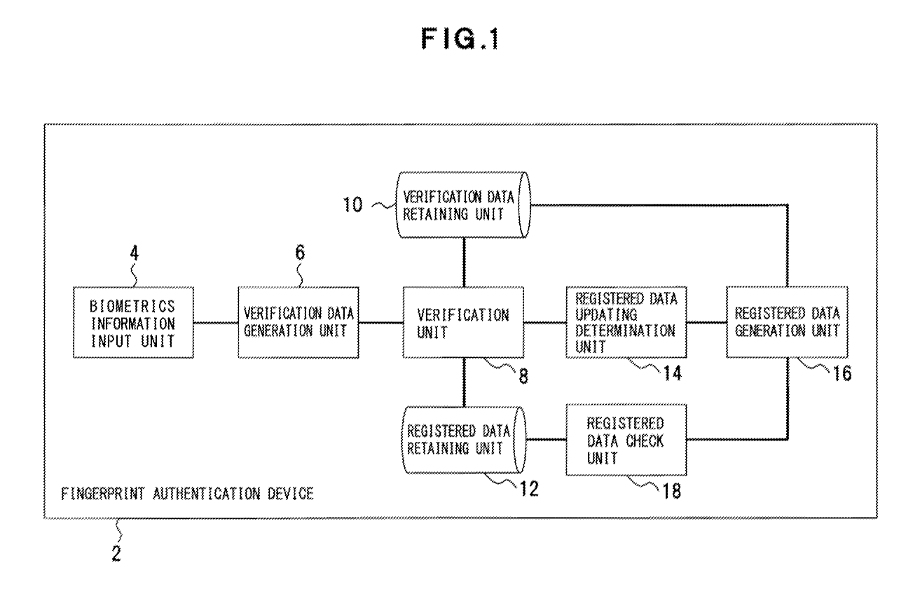

A first embodiment is described with reference to FIG. 1. FIG. 1 depicts a fingerprint authentication device according to the first embodiment. Structure depicted in FIG. 1 is one example and the present invention is not limited to such structure.

This fingerprint authentication device 2 is one example of a biometrics authentication device using biometrics information such as fingerprint information for authentication. The fingerprint authentication device 2 uses fingerprint information for authentication. This fingerprint authentication device 2 includes, as depicted in FIG. 1, a biometrics information input unit 4, a verification data generation unit 6, a verification unit 8, a verification data retaining unit 10, a registered data retaining unit 12, a registered data updating determination unit 14, a registered data generation unit 16 and a registered data check unit 18.

The biometrics information input unit 4 is a biometrics information input means (part) reading biometrics information such as a fingerprint image collected from, for example, a finger as a living body. The biometrics information input unit 4 is, e.g., configured by a sweep-type fingerprint sensor.

The verification data generation unit 6 extracts feature information used for verification from collected biometrics information. This feature information is feature point information appearing in a fingerprint image, pattern information representing a ridge form, etc.

The verification unit 8 is a determination means (part) that checks generated verification data with registered data which is pre-registered, and determines whether to be an original or not. Verification data is retained in the verification data retaining unit 10. The verification data retaining unit 10 is a storing means (part) of a plurality of pieces of verification data. Registered data is retained in the registered data retaining unit 12. The registered data retaining unit 12 is a storing means (part) of a plurality of pieces of registered data.

The registered data updating determination unit 14 is a determination means (part) that determines whether updating of registered data in the registered data retaining unit 12 is necessary or not.

The registered data generation unit 16 is a means (part) which extracts feature information of high reproducibility from registered data stored in the registered data retaining unit 12 and a plurality of pieces of verification data stored in the verification data retaining unit 10, and generates new registered data by using the extracted feature information.

The registered data check unit 18 is a check means (part) for registered data generated by the registered data generation unit 16. The registered data check unit 18 determines whether registered data to be retained in the registered data retaining unit 12 is proper or not.

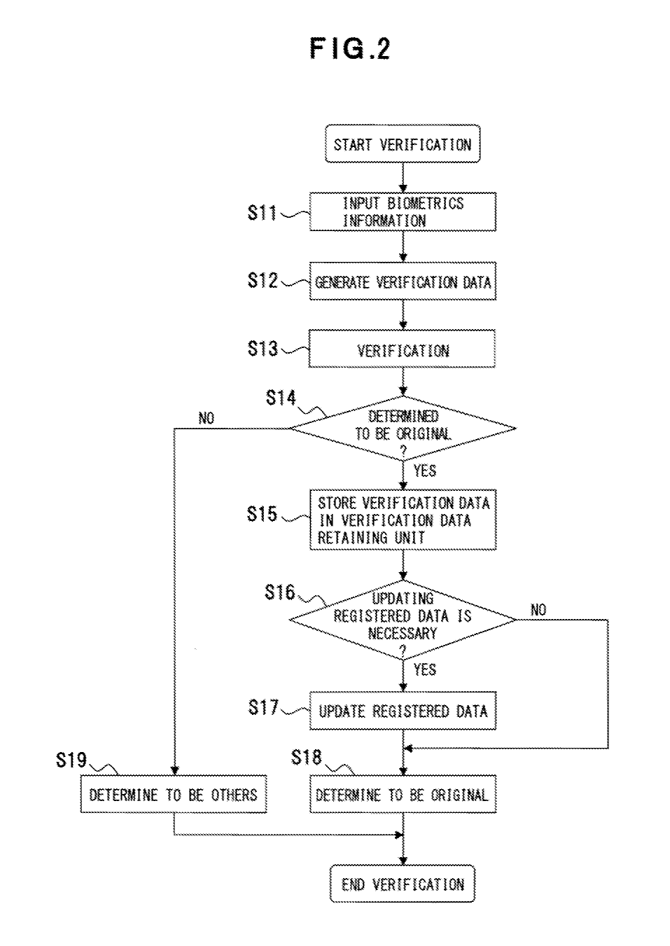

Processing procedure of fingerprint verification is described with reference to FIG. 2. FIG. 2 is a flowchart depicting processing procedure of fingerprint verification. Structure depicted in FIG. 2 is one example and the present invention is not limited to such structure.

This processing procedure of fingerprint verification uses fingerprint information as biometrics information, and embraces a generation process of verification data and processes such as storing verification data and updating registered data. In this processing procedure, as depicted in FIG. 2, when verification using fingerprint information is started, fingerprint information is inputted from the biometrics information input unit 4 (step S11). Verification data is generated by using the fingerprint information inputted from the biometrics information input unit 4 (step S12) and verification is performed with registered data which is prestored in the registered data retaining unit 12 (step S13). Based on this verification, whether to be an original or not is determined (step S14). If it is determined to be the original (YES of step S14), the verification data is stored in the verification data retaining unit 10 (step S15). That is, this verification data is stored as past verification data.

After storing this verification data, the registered data updating determination unit 14 determines necessity of updating the registered data (step S16), If it is determined that updating of the registered data is necessary (YES of step S16), the registered data is updated (step S17), and after the updating, it is determined to be the original (step S18).

In step S16, if it is determined that updating of the registered data is not necessary (NO of step S16), the original is similarly determined (step S18), and this process is ended.

In step S14, unless it is determined to be the original (NO of step S14), others are determined (step S19), and this verification process is ended.

In this embodiment, it is determined whether verification data is stored in the verification data retaining unit 10 dependently on a verification result. For example, determination may be performed by a method other than the above, for example, by providing a dedicated threshold value.

Necessity of updating registered data is determined only when it is determined to be the original by a verification result. Updating of registered data may be determined even if it is determined to be others. In this case, a method of determination by a threshold value may be performed separately.

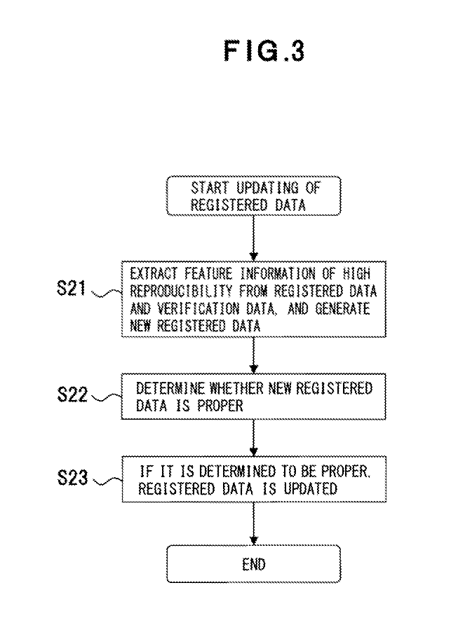

Updating of registered data is described with reference to FIG. 3 FIG. 3 is a flowchart depicting processing procedure of updating registered data. Structure depicted in FIG. 3 is one example and the present invention is not limited to such structure.

This processing procedure is one example of a method for updating registered data or a program therefor. In this processing procedure, as depicted in FIG. 3, if it is determined that updating of registered data is necessary, feature information of high reproducibility is extracted from the registered data and verification data, and new registered data is generated (step S21). The registered data check unit 18 determines whether the new registered data is proper or not (step S22). If being proper is determined, the registered data in the registered data retaining unit 12 is updated (step S23).

In this processing procedure, extraction of feature information, evaluation of reproducibility of feature information and generation of new registered data are performed by the registered data generation unit 16. In this case, for extraction of feature information of high reproducibility, for example, verification is performed between a plurality of pieces of verification data, and between current registered data and a plurality of pieces of verification data, and as a result, new registered data may be generated from feature information of matching many times.

Reproducibility is, for example, evaluated by heavily weighting current registered data. Heavily weighting current registered data allows feature information of current registered data not to change extremely, or to lessen possibility of extreme change. Thus, a risk of replacement with others' biometrics information is reduced. For example, if feature information of matching seven times is adopted out of ten pieces of data as new registered data, and is weighted, for example, three times as weighting for feature information of registered data, feature information of matching four times may exist in registered data out of remaining nine pieces of data. This is not content to which current registered data is limited in particular. If verification data of high reliability is apparent in advance, this verification data is heavily weighted and may be evaluated. Performing such process does not have a risk that feature information of current registered data is extremely changed, and since extreme change of registered data is suppressed, a bad effect of changing registered data can be avoided.

The registered data updating determination unit 14 may be configured that, for example, if a verification result in the verification unit 8 is lower than a preset threshold value, it is determined that updating is necessary. If verification results of past plural times are retained, verification results thereof can be used for updating registered data. That is, if verification results thereof are referred and necessity of updating registered data is determined, more stable determination whether to update registered data or not is enabled. If this determination is configured that for a verification result in the verification unit 8, a separately prescribed threshold value is set, a verification result therein and the threshold value are compared and when a verification result therein are larger than the threshold value (for example, if it is determined to be an original), updating registered data is performed, risk of replacement with others' biometrics information lessens.

In the registered data check unit 18, whether new registered data is proper or not is determined. That is, whether new registered data is proper is evaluation whether others' biometrics information is included in new registered data. For example, if new registered data extraordinary differs from current registered data, there is possibility that the new registered data is separated from biometrics information of an original and includes much feature information of others, or that performing verification will become difficult afterwards. Therefor, difference between current registered data and new registered data is calculated and if difference therebetween is equal to or below a preset threshold value, proper data may be determined. If feature information of new registered data is less than a threshold value (for example, if extracted feature points are less than a threshold level in a feature point method), determination of proper data is avoided. Only if feature information of new registered data is more than a threshold value, it may be determined to be proper data. Such process allows avoiding a cause of a verification error, etc.

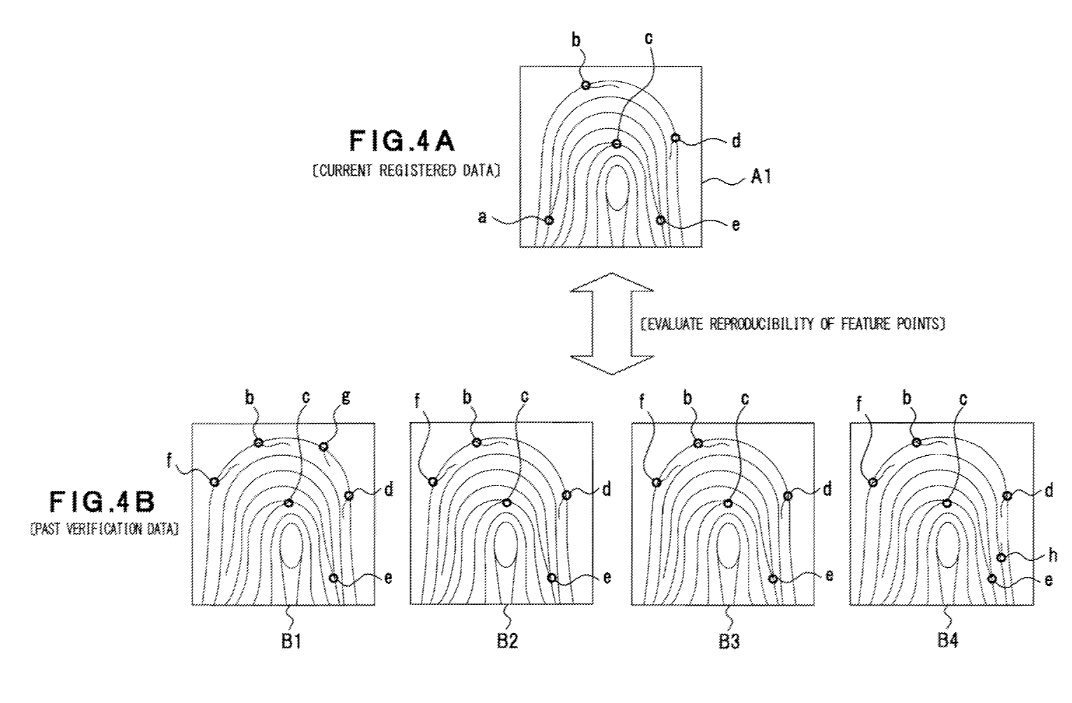

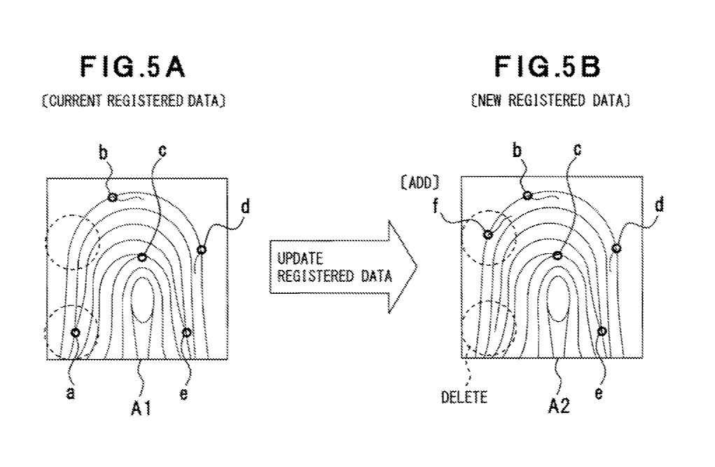

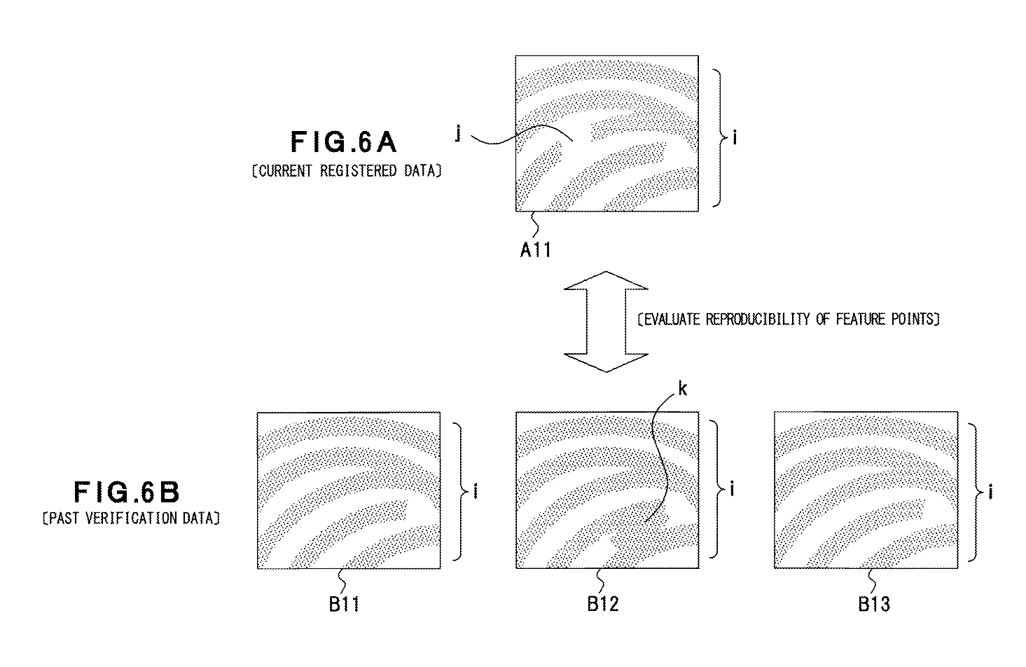

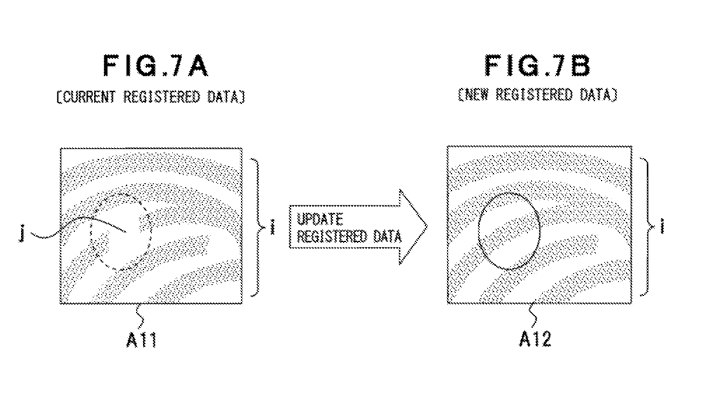

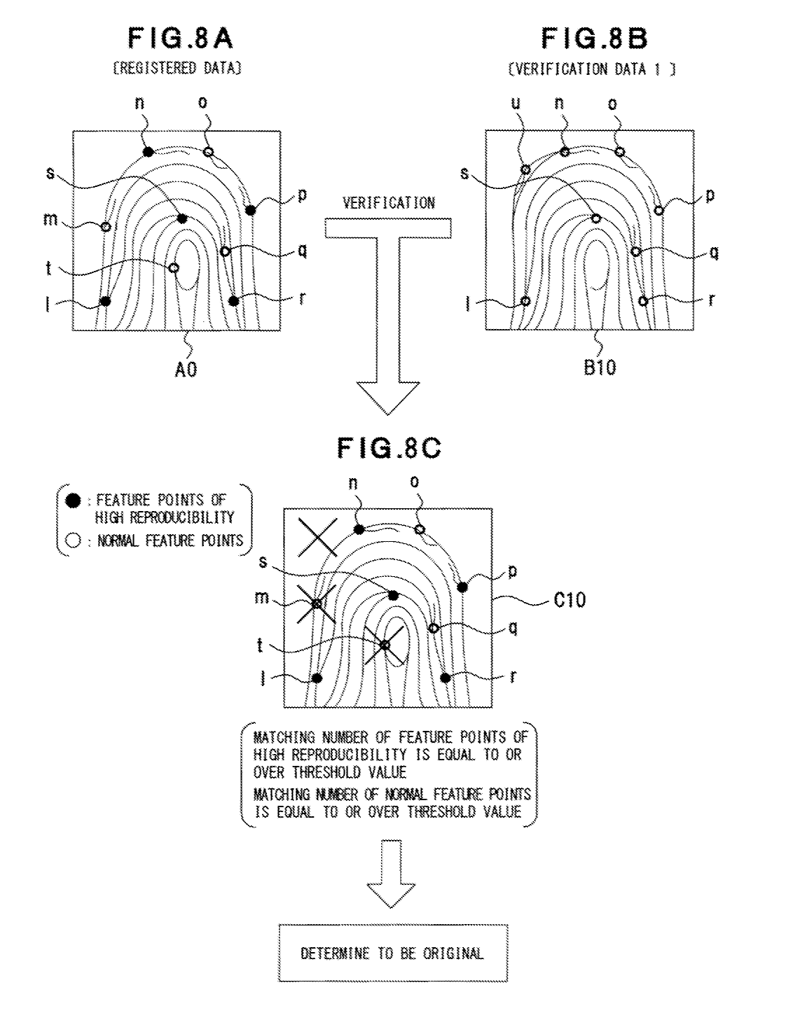

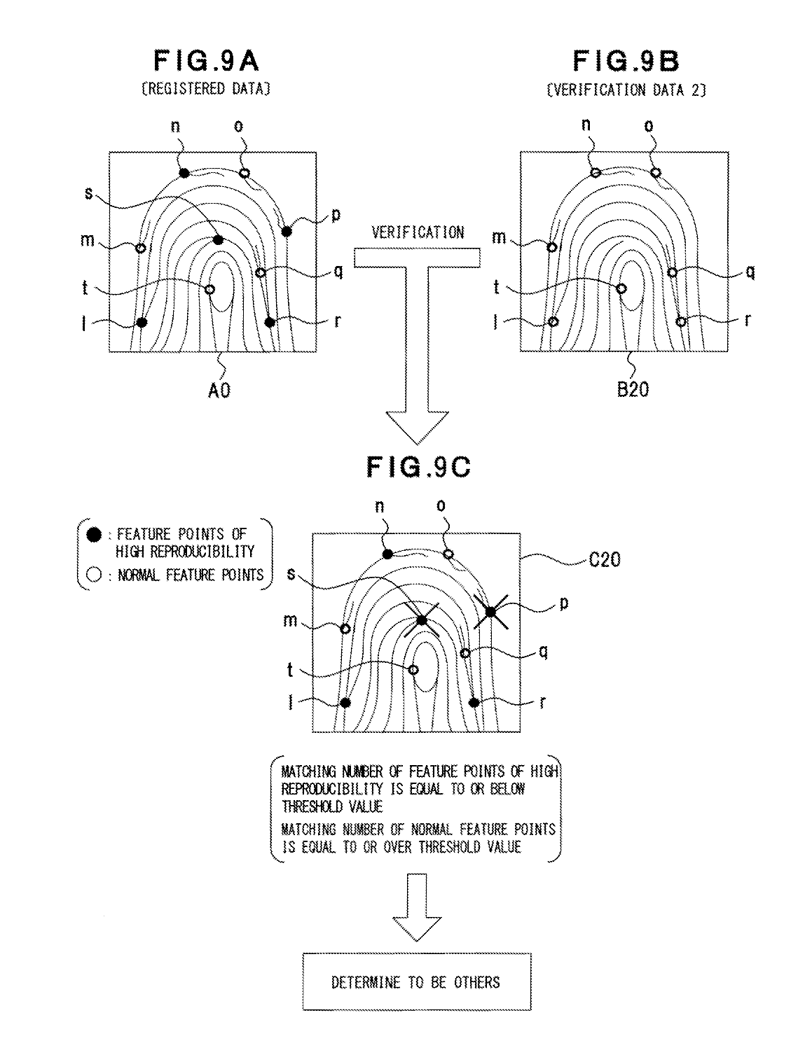

An updating process of registered data is described with reference to FIGS. 4A, 4B, 5A, 5B, 6A, 6B, 7A, 7B, 8A-8C and 9A-9C. FIGS. 4A, 4B, 5A and 5B depict an updating process of registered data using a feature point method, FIGS. 6A, 6B, 7A and 7B depict an updating process of registered data using a registration template method, and FIGS. 8A-8C and 9A-9C depict an updating process of weighted registered data. Structure depicted in FIGS. 4A-9C is one example and the present invention is not limited to such structure.

a) Feature Point Method

As to update of registered data, in a feature point method, as depicted in FIGS. 4A and 4B, reproducibility of each feature point is evaluated and based on a result of evaluation thereof, as depicted in FIGS. 5A and 5B, new registered data may be generated. In the registered data retaining unit 12, current registered data A1 (FIG. 4A) is registered. This current registered data A1 is, for example, a fingerprint image. This current registered data A1 has, as depicted in FIG. 4A, feature points a, b, c, d and e. Each of the feature points a, b, c, d and e is a branch of a ridge of a fingerprint that is a living body, etc. On the contrary, in the verification data retaining unit 10, a plurality of pieces of verification data B1, B2, B3 and B4 (FIG. 4B) that were used in past verification are registered. Each piece of verification data B1, B2, B3 and B4 is a fingerprint image similarly. As depicted in FIG. 4B, the verification data B1 has feature points f and g that the registered data A1 does not have, along with the feature points b, c, d and e, but lacks the feature point a. The verification data B2 and B3 have a feature point f that the registered data A1 does not have, along with the feature points b, c, d and e, but lacks the feature point a. The verification data B4 has a feature point h that the registered data A1 does not have, along with the feature points b, c, d and e, but lacks the feature point a.

The above being seen concerning the feature points a, b, c, d, e, f, g and h, the feature points a, b, c, d and e exist in the registered data A1, the feature points b, c, d, e, f and g exist in the verification data B1, the feature points b, c, d, e and f exist in the verification data B2 and B3, and the feature points b, c, d, e, f and h exist in the verification data B4.

Verification data is evaluated by reproducibility of these feature points, that is, existence thereof or not. As a result of the evaluation, the feature point f of high reproducibility exists in the verification data B1 to B4, and the feature point a of low reproducibility exists in the current registered data A1.

Based on the evaluation of reproducibility of feature points, update of a registration template is performed. As depicted in FIG. 5A, since the feature point a of low reproducibility exists and the feature point f of high reproducibility does not exist in the current registered data A1, as depicted in FIG. 5B, the feature point a of low reproducibility is deleted, new registered data A2 that the feature point f of high reproducibility is added to is generated, and the current registered data A1 is updated to the new registered data A2.

b) Pattern Matching Method

As to update of registered data, in a pattern matching method, as depicted in FIGS. 6A and 6B, reproducibility of each pattern is evaluated and based on a result of the evaluation, as depicted in FIGS. 7A and 7B, new registered data may be generated. In the registered data retaining unit 12, current registered data A11 (FIG. 6A) is registered. This current registered data A11 is, for example, a fingerprint image. This current registered data A11 is, as depicted in FIG. 6A, a pattern image that has a missing part j as feature information on a pattern line i. The missing part j is, if it is a part of a fingerprint, a missing part of a ridge, etc. On the contrary, in the verification data retaining unit 10, a plurality of pieces of verification data B11, B12 and B13 (FIG. 6B) that were used in past verification are registered. Each piece of the verification data B11, B12 and B13 is a fingerprint image similarly. As depicted in FIG. 6B, while the verification data B11 and B13 are pattern images composed of pattern lines where the missing part j does not occur, the verification data B12 is a pattern image where a short part k occurs between pattern lines.

The above being seen concerning a pattern of the pattern line i, the missing part j and the short part k, the missing part j exists but the short part k does not exist in the registered data A11. The missing part j and the short part k do not exist in the verification data B11 and B13. The missing part j does not exist but the short part k exists in the verification data B12.

The verification data B11-B13 are evaluated by reproducibility of these patterns, that is, forms of patterns and existence or not of the missing part j and the short part k. As a result of the evaluation, a pattern that the missing part j and the short part k do not exist, as feature points of high reproducibility, exists in the verification data B11 and B13, and the missing part j that is a feature point of low reproducibility exists in the current registered data A11.

Then, reproducibility of a pattern is evaluated, and based on a result of the evaluation, update of a registration template is performed. As depicted in FIG. 7A, the missing part j of low reproducibility exists in the current registered data A11. As depicted in FIG. 7B, new registered data A12 is generated by supplementing a pattern line to the missing part j of low reproducibility, and the current registered data A11 is updated to the new registered data A12.

Concerning update of registered data (the feature point method and the pattern matching method), old registered data may be stored in the verification data retaining unit 10 after such updating of registered data.

In order to reduce influence on a verification result and authentication by change of biometrics information over the years, registered data is made from verification data after a set period of time, that is, verification data that has been used for a long time, not made only from the latest verification data. Thus, stable registered data can be made. Therefore, feature information stored in the verification data retaining unit 10 may be stored so that another piece of the feature information is stored after a certain time since one piece of the feature information has been stored last. According to such process, verification accuracy can be improved by stable registered data.

If there is no storage area for storing new data in the verification data retaining unit 10, verification data to be deleted may be determined according to reliability of each piece of verification data. According to such structure, since unnecessary verification data is not stored, recording efficiency of a storing means (part) set in the verification data retaining unit 10 can be improved.

For calculation of reliability, for example, a method that the oldest verification data in chronological order is deleted, or that deletion is performed dependently on a verification result between pieces of verification data may be used. For utilizing an area of the verification data retaining unit 10 effectively, feature information stored in the verification data retaining unit 10 may be only difference from registered data. In this case, in updating of the registered data, verification data can be obtained from the registered data and each difference.

Feature matters, variations, etc. extracted from the above described first embodiment are listed below.

(1) In this fingerprint authentication device 2, as described above, the verification data retaining unit 10 storing a plurality of pieces of verification data by which authentication was successful in the past is included. In updating of registered data, feature points (the feature amount) of high reproducibility are extracted from past verification data stored in the verification data retaining unit 10 and current registered data, and the extracted feature points can be rendered new registered data.

(2) Both registered data updating by the feature point method and registered data updating by the pattern matching method are adaptable to an updating process of registered data. Evaluation of reproducibility is not limited to the above described embodiment, neither.

(3) As to verification data stored in the verification data retaining unit 10, storage is not performed from new data in order, but data after a long time interval (for example, by season) may be stored. Such structure is adaptable to change of a living body over the years immediately.

(4) If an upper limit of feature points (the feature amount) changed from current registered data is determined, a risk of further replacing with information of another finger can be reduced.

(5) Concerning data stored in the verification data retaining unit 10, since all pieces of verification data are not stored and only difference from registered data (since authentication is successful about the data, the difference is small) is stored, a storage area can be reduced.

(6) In updating registered data, reliability of each of the feature amount is recorded along with the feature amount, and when a verification score is calculated, the feature amount of high reliability is weighted and evaluation may be performed.

(7) Since reliability of each of the feature amount is evaluated from verification data of past plural times and based on reliability thereof, registered data is updated, registered data of high reliability in view of change over the years can be held.

(8) Since registered data is updated, if a living body is changed over the years, the registered data is adaptable. Thus, not only suppression of authentication accuracy, but also more improvement of authentication accuracy can be achieved.

(9) Since only the feature amount of high reliability (reproducibility) is rendered registered data, a risk of replacing a finger by a verification error is extremely low, and only the feature amount extracted stably can be registered. That is, a verification error by the unstable feature amount can be prevented.

### Second Embodiment

A second embodiment is described with reference to FIGS. 8A to 9C. FIGS. 8A-8C depict a verification process where weighting is performed dependently on reproducibility of feature points, and FIGS. 9A-9C depict another verification process where weighting is performed dependently on reproducibility of feature points. Structure depicted in FIGS. 8A to 9C is one example and the present invention is not limited to such structure.

In the registered data retaining unit 12, degree of reproducibility of each piece of feature information is retained together. In verification, weighting is performed according to the degree of reproducibility of feature information and verification may be executed. This embodiment is a verification example in a case of, according to reproducibility of feature information, having two types of feature point information (normal feature point information and feature point information of high reproducibility) in advance as the feature information.

In this verification process, as depicted in FIG. 8A, in registered data A0, a plurality of feature points l, m, n, o, p, q, r, s and t are registered. In these feature points l, m, n, o, p, q, r, s and t, the feature points l, n, p, r and s are feature point information of high reproducibility, and the others are normal feature point information. The feature point information of high reproducibility represents feature points of higher reproducibility than the normal feature points. In contrast, the verification data B10, as depicted in FIG. 8B, includes a plurality of feature points l, n, o, p, q, r, s and u.

This verification data B10 being checked with the registered data A0, as depicted in FIG. 8C, a verification result C10 is obtained. In this verification result C10, the feature points l, n, o, p, q, r and s correspond with the registered data A0. The corresponding feature points l, n, o, p, q, r and s include the feature points of high reproducibility l, n, p, r and s, and the corresponding number is five. For this corresponding number, if a certain threshold value is set as th and th=5, the corresponding number of the feature points of high reproducibility is equal to or over the threshold value th five, and the corresponding number of the normal feature points is also equal to or over the threshold value th five, the verification data B10 is biometrics information of an original, and as a result of authentication, the original is determined.

In this verification process, as depicted in FIG. 9A, in the registered data A0, as described above, a plurality of the feature points l, m, n, o, p, q, r, s and t are registered. In these feature points l, m, n, o, p, q, r, s and t, the feature points l, n, p, r and s are the feature point information of high reproducibility, and the others are the normal feature point information. In contrast, the verification data B20, as depicted in FIG. 9B, includes a plurality of the feature points l, m, n, o, q, r and t.

This verification data B20 being checked with the registered data A0, as depicted in FIG. 9C, a verification result C20 is obtained. In this verification result C20, the feature points l, m, n, o, q, r and t correspond with the registered data A0. The corresponding feature points l, m, n, o, q, r and t include the feature points of high reproducibility l, n and r, and the feature points of high reproducibility s and q are not included. Thus, the corresponding number thereof is three. For this corresponding number, if a certain threshold value is set as th and th=5, while the corresponding number of the normal feature points is equal to or over the threshold value th five, the corresponding number of the feature points of high reproducibility is below the threshold value th five. Therefore, the verification data B20 is not said to be biometrics information of an original, and as a result of authentication, it is determined to be others.

As the above, although the corresponding number of the normal feature points is equal to or over a threshold value, acceptance of others can be reduced without increasing refusal of an original by determining to be others if the feature points of high reproducibility is equal to or below the threshold value.

An example of being divided into two types of feature point information in advance is presented hereinabove. Of course, division into more than two types may be executed. Numerals representing reproducibility is preassigned to each feature point, and each feature point may be weighted. In this case, for example, a verification score 10 is calculated in both cases where five feature points of weight 2 correspond, and where ten feature points of weight 1 correspond.

Therefore, using such embodiment also allows obtaining the same effects as the above embodiment.

### Third Embodiment

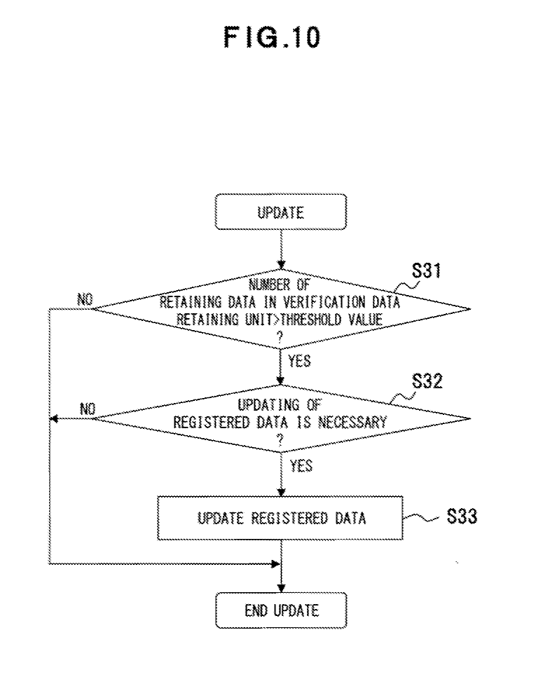

A third embodiment is described with reference to FIG. 10. FIG. 10 is a flowchart depicting processing procedure of a registered data updating process except in verification. Structure depicted in FIG. 10 is one example and the present invention is not limited to such structure.

An updating process of registered data except in verification is one example of a biometrics authentication method or a biometrics authentication program. This registered data updating process includes a process of setting a threshold value for the number of retaining verification data.

In the updating process of registered data except in verification, as depicted in FIG. 10, a threshold value is set for the number of retaining data in the verification data retaining unit 10, and whether the number of retaining data therein is over the threshold value or not is determined (step S31). Unless the number of retaining data is over the threshold value (NO of step S31), since update of registered data is not necessary, this updating process is ended. If the number of retaining data is over the threshold value (YES of step S31), whether updating registered data is necessary is determined (step S32). If updating of registered data is not necessary (NO of step S32), this updating process is ended. If updating of registered data is necessary (YES of step S32), updating of registered data is executed (step S33), and after updating registered data, this updating process is ended.

Therefore, using such embodiment also allows obtaining the same effects as the above embodiments.

### Fourth Embodiment

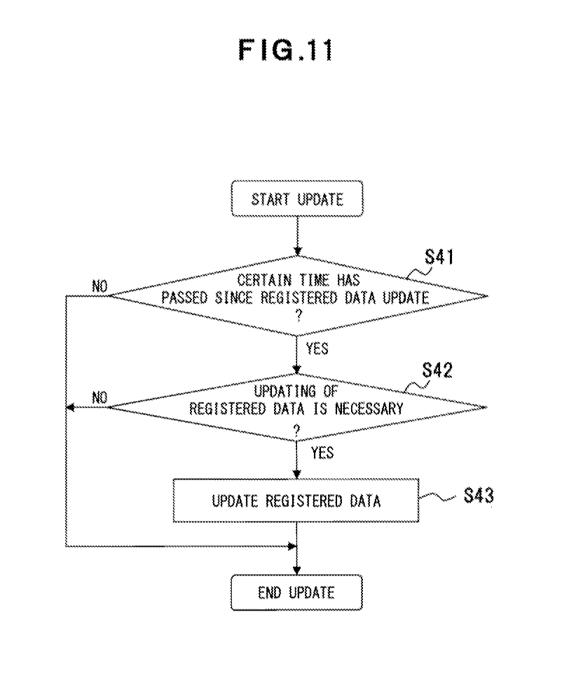

A fourth embodiment is described with reference to FIG. 11. FIG. 11 is a flowchart depicting processing procedure of a registered data updating process except in verification. Structure depicted in FIG. 11 is one example and the present invention is not limited to such structure.

An updating process of registered data except in verification is one example of a biometrics authentication method or a biometrics authentication program. This registered data updating process includes a process using passage of certain time as occasion for updating data.

In another updating process of registered data except in verification, as depicted in FIG. 11, passage of certain time since updating of registered data is monitored (step S41). Unless certain time has passed since updating registered data (NO of step S41), because update of registered data is not necessary, this updating process is ended. If certain time has passed since updating registered data (YES of step S41), whether updating registered data is necessary is determined (step S42). If updating of registered data is not necessary (NO of step S42), this updating process is ended. If updating of registered data is necessary (YES of step S42), updating of registered data is executed (step S43), and after updating registered data, this updating process is ended.

Therefore, using such embodiment also allows obtaining the same effects as the above embodiments.

### Fifth Embodiment

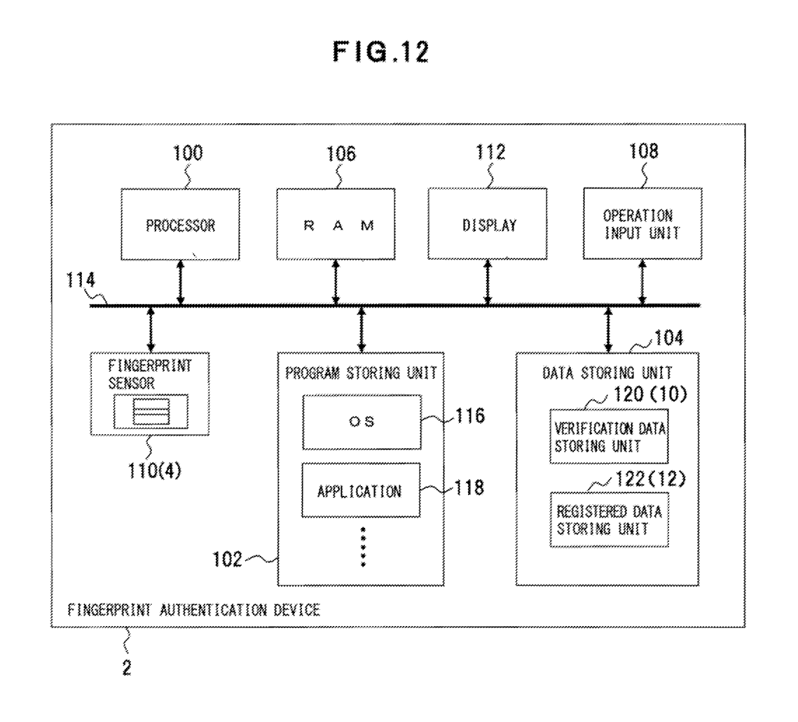

A fifth embodiment is described with reference to FIG. 12. FIG. 12 depicts a hardware configuration of a fingerprint authentication device according to the fifth embodiment. Structure depicted in FIG. 12 is one example and the present invention is not limited to such structure. In FIG. 12, the same components as FIG. 1 are denoted by the same reference numerals.

This fingerprint authentication device 2 is configured with a computer as an information processing means (part) for obtaining an image and fingerprint authentication. Disposed are a processor 100, a program storing unit 102, a data storing unit 104, a RAM (Random-Access Memory) 106, an operation input unit 108, a fingerprint sensor 110 and a display 112. These are cooperated with by a bus 114.

The processor 100 is, for example, composed of a CPU (Central Processing Unit). The processor 100 is a control means (part) for obtaining a biometrics image such as a fingerprint image, checking registered data with verification data, performing a process of updating registered data, and storing and calculating various kinds of data and so on by execution of an OS (Operating System) and an application program such as a slide tuning program. The processor 100 corresponds to the above described verification data generation unit 6, the verification unit 8, the registered data updating determination unit 14, the registered data generation unit 16, the registered data check unit 18, etc. along with the RAM 106.

The program storing unit 102 is one example of a recording means (part) recording a program, and is configured by a computer readable and writable recording medium. In this program storing unit 102, an OS 116 and a routine of an application program 118 such as a biometrics authentication program are stored.

The data storing unit 104 corresponds to the above described verification data retaining unit 10 and the registered data retaining unit 12, is one example of a storing means (part) storing data, and stores a fingerprint image and slide information. In this data storing unit 104, a verification data storing unit 120 and a registered data storing unit 122 are set.

The RAM 106 configures a work area. The operation input unit 108 is used for inputting information and so on. A keyboard and the like are used for inputting information. The display 112 is an information presenting means (part), and for example, is configured by an LCD (Liquid Crystal Display).

The fingerprint sensor 110 is one example of the above described biometrics information input unit 4, is a means (part) for detecting fingerprints from a sliding finger and taking a fingerprint image, and for example, is configured by a sweep-type fingerprint sensor.

According to such structure, the above described fingerprint authentication device 2 is composed, and processes such as making verification data, making registered data, and updating and verifying the made data are executed.

Therefore, using such embodiment also allows obtaining the same effects as the above embodiments.

### Other Embodiments

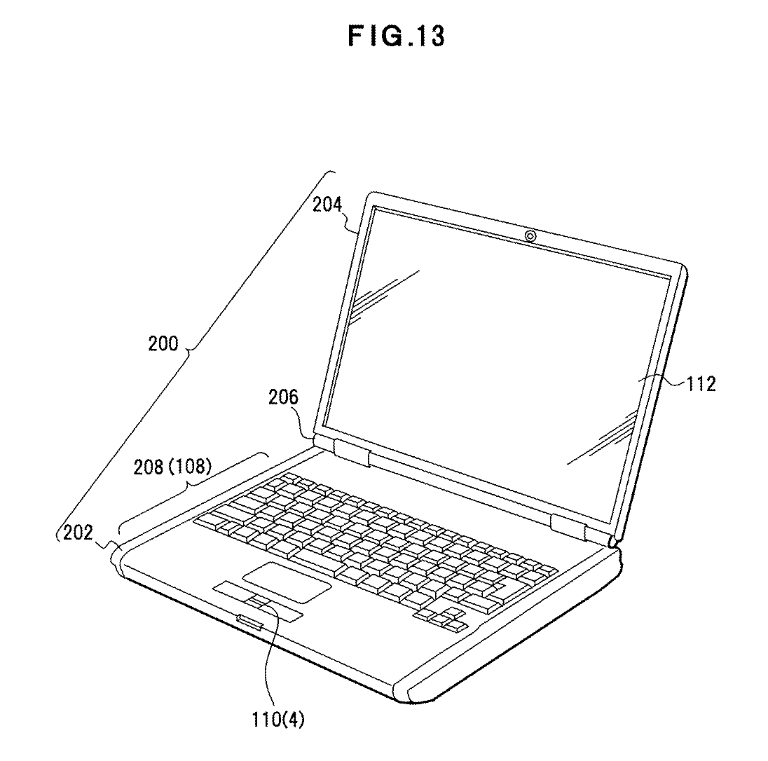

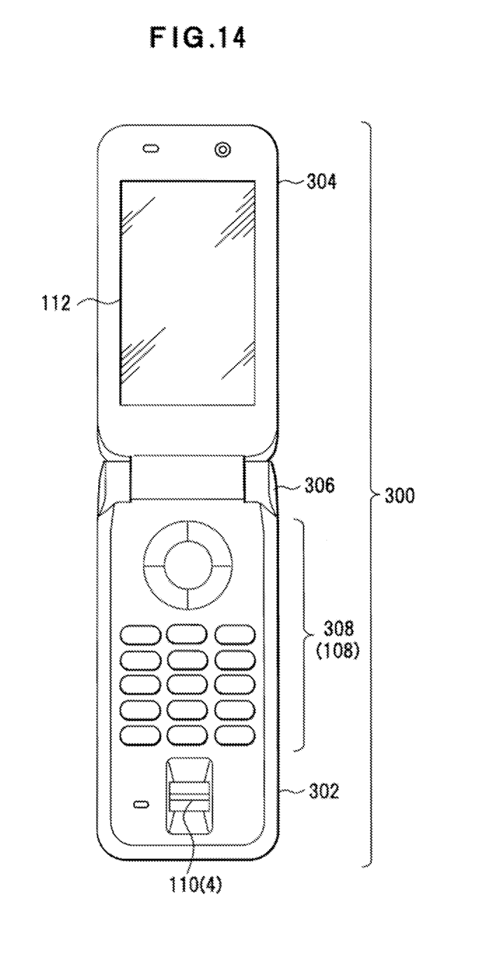

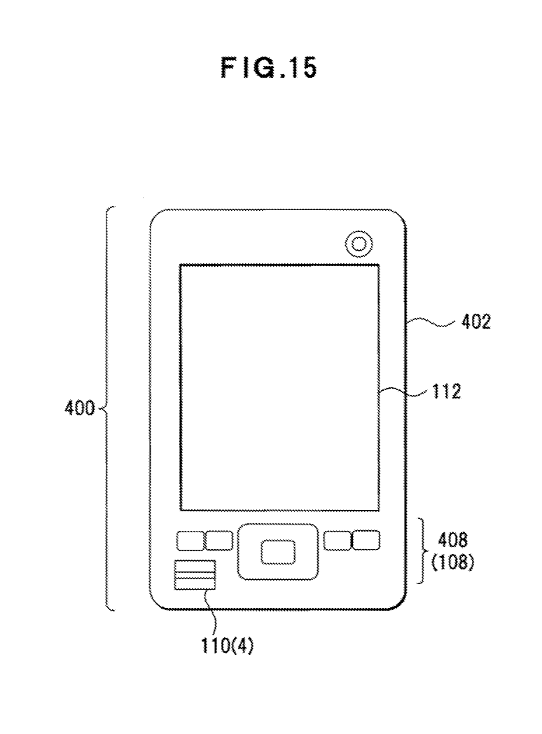

(1) The above described fingerprint authentication device 2 is mounted on various electronic devices such as a personal computer (PC) 200 (FIG. 13), a portable device 300 (FIG. 14) and a personal digital assistant (PDA) 400 (FIG. 15). The PC 200 is, as depicted in FIG. 13, configured so that a housing 202 and a housing 204 can be opened and closed by a hinge 206. On the housing 202, a keyboard 208 (one example of the operation input unit 108) is disposed, and the fingerprint sensor 110 is disposed. On the housing 204, the display 112 is mounted.

According to such structure, in the PC 200, registered data of fingerprint information inputted from the fingerprint sensor 110 is updated, an authentication error such as acceptance of others and refusal of an original by change of a living body over the years can be prevented, and biometrics authentication of high reliability can be performed.

The portable device 300 is, as depicted in FIG. 14, configured so that a housing 302 and a housing 304 can be opened and closed by a hinge 306. On the housing 302, a keyboard 308 (one example of the operation input unit 108) is disposed, and the fingerprint sensor 110 is disposed. On the housing 304, the display 112 is mounted.

Similarly, in the portable device 300, registered data of fingerprint information inputted from the fingerprint sensor 110 is updated, an authentication error such as acceptance of others and refusal of an original by change of a living body over the years can be prevented, and biometrics authentication of high reliability can be performed.

In the PDA 400, as depicted in FIG. 15, on the housing 402, mounted are a keyboard 408 (one example of the operation input unit 108), the fingerprint sensor 110 and the display 112.

Similarly, in the PDA 400, registered data of fingerprint information inputted from the fingerprint sensor 110 is updated, an authentication error such as acceptance of others and refusal of an original by change of a living body over the years can be prevented, and biometrics authentication of high reliability can be performed.

(2) In the above embodiments, a fingerprint authentication device is exemplified as a biometrics authentication device. The present invention is applicable to a biometrics authentication device and a biometrics authentication method using, for example, vein authentication or iris authentication except fingerprint authentication, a biometrics authentication program and a recording medium thereof. The present invention is not limited to the above embodiments.

Technical ideas extracted from the embodiments of the present invention described above are listed. The technical ideas according to the present invention can be obtained by various levels and variations from a generic concept to a more specific concept, and following description do not limit the present invention.

In the biometrics authentication device, preferably, the registered data generation unit may perform verification between the verification data in the verification data retaining unit, and perform verification between a plurality of pieces of the verification data and the registered data in the registered data retaining unit, and by both of the verification, new registered data may be generated by using feature information of matching many times.

In the biometrics authentication device, preferably, when evaluating degree of reproducibility, the registered data generation unit may perform weighting of registered data or verification data that is designated in advance to evaluate degree thereof.

Preferably, the biometrics authentication device may comprise a biometrics information input unit to input biometrics information; a verification data generation unit to extract feature information for verification from inputted biometrics information; and a verification unit to verify the verification data with pre-registered registered data, wherein if a verification result in the verification unit is larger than a prescribed threshold value, the verification data may be newly stored in the verification data retaining unit.

Preferably, the biometrics authentication device may comprise a registered data updating determination unit to determine whether updating of registered data is necessary or not, wherein only if the registered data updating determination unit determines that data updating is necessary, the registered data may be updated.

In the biometrics authentication device, preferably, if a verification result in the verification unit is smaller than a first threshold value which is prescribed, the registered data updating determination unit may determine that updating is necessary.

In the biometrics authentication device, preferably, the registered data updating determination unit may retain verification results of past plural times, and if any of the verification results is smaller than a first threshold value which is prescribed, the registered data updating determination unit may determine that updating is necessary.

In the biometrics authentication device, preferably, if a verification result in the verification unit is larger than a second threshold value which is prescribed, the registered data updating determination unit may determine that updating is necessary.

Preferably, the biometrics authentication device may comprise a registered data check unit to determine whether the new registered data generated by the registered data generation unit is proper, wherein in registered data updating, only if the new registered data is determined to be proper by the registered data check unit, the registered data may be updated.

In the biometrics authentication device, preferably, the registered data check unit may compare difference between the new registered data generated by the registered data generation unit and current registered data, and if the difference is equal to or below a predetermined threshold value, it may be determined that the new registered data is proper.

In the biometrics authentication device, preferably, the registered data check unit may determine that the new registered data is proper if the amount of feature information of the new registered data is more than a threshold value.

In the biometrics authentication device, preferably, the registered data and the verification data may be feature point information respectively, and the registered data generation unit may extract feature point information of high reproducibility and generate new registered data.

In the biometrics authentication device, preferably, the registered data and the verification data may be pattern information respectively, and the registered data generation unit may extract pattern information of high reproducibility and generate new registered data.

In the biometrics authentication device, preferably, old registered data may be stored in the verification data retaining unit after updating the registered data.

In the biometrics authentication device, preferably, the verification data stored in the verification data retaining unit may be data passed over a certain period.

In the biometrics authentication device, preferably, if there is no area for newly storing data in the verification data retaining unit, reliability of feature information stored in the verification data retaining unit may be evaluated, data of the lowest reliability may be deleted, and new data may be added.

In the biometrics authentication device, preferably, the reliability may be determined by time, that is, data stored in the furthest past may be deleted.

In the biometrics authentication device, preferably, the reliability may be determined by a verification result, that is, verification may be performed for each piece of stored data and as a result of the verification, data of the worst verification result may be deleted.

In the biometrics authentication device, preferably, the verification data retaining unit may store only a different part from current registered data.

In the biometrics authentication device, preferably, degree of reproducibility of feature information may be retained together in the registered data retaining unit, and in verification, the verification may be performed with weighting in accordance with the degree of reproducibility of the feature information.

The following effects can be obtained according to the embodiments of the present invention.

(1) The embodiments are adaptable to change of a living body such as fingerprints over the years, can prevent the risk that in updating of registered data, the registered data is replaced with biometrics information such as others' finger, and can perform updating by using only stable extracted feature information as registration feature information.

(2) Registered data can be updated with feature information of high reproducibility obtained from biometrics information such as fingerprint information gained from a living body where change over the years occurs. Using such registered data can realize authentication of high reliability.

While the most preferred embodiments of the present invention have been described hereinabove, the present invention is not limited to the above embodiments, and it is a matter of course that various variations and modifications can be made by those skilled in the art within the scope of the claims and the disclosed embodiments without departing from the spirit of the invention disclosed herein, and needless to say, such variations and modifications are also encompassed in the scope of the present invention.

The embodiments of the present invention relate to biometrics authentication using biometrics information such as fingerprint information, are adaptable to change of a living body such as fingerprints over the years, can prevent the risk that in updating of registered data, the registered data is replaced with biometrics information such as others' finger, and can perform updating by using only stable extracted feature information as registration feature information. The embodiments of the present invention can be broadly used for not only fingerprint authentication but also biometrics authentication using biometrics information accompanying with change over the years, thus are useful.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A biometrics authentication device comprising:
a registered data retaining unit to retain registered data;
a verification data retaining unit to retain a plurality of pieces of verification data used for verification with the registered data; and
a registered data generation unit to extract feature information of high reproducibility from the verification data in the verification data retaining unit and the registered data in the registered data retaining unit, and to generate new registered data from extracted feature information,
wherein by the new registered data generated by the registered data generation unit, the registered data in the registered data retaining unit is updated.

2. The biometrics authentication device of claim 1, wherein the registered data generation unit performs verification between the verification data in the verification data retaining unit, and performs verification between a plurality of pieces of the verification data and the registered data in the registered data retaining unit, and by both of the verification, new registered data is generated by using feature information of matching many times.

3. The biometrics authentication device of claim 1, wherein when evaluating degree of reproducibility, the registered data generation unit performs weighting of registered data or verification data that is designated in advance to evaluate degree thereof.

4. The biometrics authentication device of claim 1, comprising a biometrics information input unit to input biometrics information;
a verification data generation unit to extract feature information for verification from inputted biometrics information; and
a verification unit to verify the verification data with pre-registered registered data,
wherein if a verification result in the verification unit is larger than a prescribed threshold value, the verification data is newly stored in the verification data retaining unit.

5. The biometrics authentication device of claim 1, comprising
a registered data updating determination unit to determine whether updating of registered data is necessary or not,
wherein only if the registered data updating determination unit determines that data updating is necessary, the registered data is updated.

6. The biometrics authentication device of claim 5, wherein if a verification result in the verification unit is smaller than a first threshold value which is prescribed, the registered data updating determination unit determines that updating is necessary.

7. The biometrics authentication device of claim 5, wherein the registered data updating determination unit retains verification results of past plural times, and if any of the verification results is smaller than a first threshold value which is prescribed, the registered data updating determination unit determines that updating is necessary.

8. The biometrics authentication device of claim 6, wherein if a verification result in the verification unit is larger than a second threshold value which is prescribed, the registered data updating determination unit determines that updating is necessary.

9. The biometrics authentication device of claim 1, comprising
a registered data check unit to determine whether the new registered data generated by the registered data generation unit is proper,
wherein in registered data updating, only if the new registered data is determined to be proper by the registered data check unit, the registered data is updated.

10. The biometrics authentication device of claim 9, wherein the registered data check unit compares difference between the new registered data generated by the registered data generation unit and current registered data, and if the difference is equal to or below a predetermined threshold value, it is determined that the new registered data is proper.

11. The biometrics authentication device of claim 9, wherein the registered data check unit determines that the new registered data is proper if the amount of feature information of the new registered data is more than a threshold value.

12. The biometrics authentication device of claim 1, wherein
the registered data and the verification data are feature point information respectively, and
the registered data generation unit extracts feature point information of high reproducibility and generates new registered data.

13. The biometrics authentication device of claim 1, wherein
the registered data and the verification data are pattern information respectively, and
the registered data generation unit extracts pattern information of high reproducibility and generates new registered data.

14. The biometrics authentication device of claim 1, wherein old registered data is stored in the verification data retaining unit after updating the registered data.

15. The biometrics authentication device of claim 1, wherein the verification data stored in the verification data retaining unit is data passed over a certain period.

16. The biometrics authentication device of claim 1, wherein if there is no area for newly storing data in the verification data retaining unit, reliability of feature information stored in the verification data retaining unit is evaluated, data of the lowest reliability is deleted, and new data is added.

17. The biometrics authentication device of claim 16, wherein the reliability is determined by time, that is, data stored in the furthest past is deleted.

18. The biometrics authentication device of claim 16, wherein the reliability is determined by a verification result, that is, verification is performed for each piece of stored data and as a result of the verification, data of the worst verification result is deleted.

19. The biometrics authentication device of claim 1, wherein the verification data retaining unit stores only a different part from current registered data.

20. The biometrics authentication device of claim 1, wherein degree of reproducibility of feature information is retained together in the registered data retaining unit, and in verification, the verification is performed with weighting in accordance with the degree of reproducibility of the feature information.

21. A computer readable and writable recording medium storing a biometrics authentication program, the program being executed by a computer, the program comprising:
retaining registered data;
retaining a plurality of pieces of verification data used for verification with the registered data;
extracting feature information of high reproducibility from the verification data and the registered data, and generating new registered data from extracted feature information; and
updating the registered data by newly generated registered data.

22. A biometrics authentication method performing authentication by biometrics information, the method comprising:
retaining registered data;
retaining a plurality of pieces of verification data used for verification with the registered data;
extracting feature information of high reproducibility from the verification data and the registered data, and generating new registered data from extracted feature information; and
updating the registered data by newly generated registered data.
